(19) United States
(12) Patent Application Publication
(10) Pub. No.: US 2004/0144006 A1
(43) Pub. Date: Jul. 29, 2004

(54) Dynamical rolling effect sign tag and method of making the same

(76) Inventor: Chao-Tien Chu, Taichung (TW)

Correspondence Address: BACON & THOMAS, PLLC, 625 SLATERS LANE, FOURTH FLOOR, ALEXANDRIA, VA, 22314

(21) Appl. No.: 10/348,945

(22) Filed: Jan. 23, 2003

(51) Int. Cl. G09F 19/14

(52) U.S. Cl. 40/453

(57) ABSTRACT

A sign tag comprises a transparent main member having convex members at a side thereof and a pattern at the opposite side thereof and there is a phase deviation between the pattern and the convex members. A base layer is further provided on the second side of the main member sheltering the pattern. The pattern has compressed elements and the convex members serve as convex lens to refract lights reflected from the relative compressed elements of the pattern to form viewing results to a viewer. The positions of the viewing results are changed according to the viewing angle of the viewer such that the viewer will get a dynamically visual effect on the sign tag when he/she changes the viewing angles continuously relative to the sign tag. The method of manufacturing the sign tag comprises the step of preparing the transparent main member and then providing the convex members, the pattern and the base layer on the first and the second sides of the main member respectively.

### BACKGROUND OF THE INVENTION

1. Field of the Invention

The present invention relates to a sign tag, and more particularly to a sign tag which can show dynamical rolling effect to distinguish themselves from the other products and create brand name recognition from the designated logo, trademark, service mark or signed tag comes along with the product.

2. Description of the Related Art

The commercial products always come along with the logo, trademark, service mark or signed tag, those signed tags are the second look after the consumers look at the product itself. The signed tags play an important role in influencing the buying decision of the consumers. Traditionally, the designated logo, trademark, service mark or signed tags are ink-printed or embroidered on the surface of the product itself. Due to the limitation of printed or embroidered result, the tags are limited as static presentation and are easily reproduced by the illegal copycats. The present invention serves a dual purpose of promoting the brand names as well as protecting the interest of proprietors.

In the prior art, there was a pattern (picture) changing plastic card. A viewer changes his or her viewing angles on the card, he or she will see two different patterns (pictures) changed repeatedly. The theory on the above card is to slice those two different patterns (pictures) into many slim lines and rearrange one to each other consecutively at intervals, i.e., one sliced line of pattern B right underneath one sliced line of pattern A and one sliced line of pattern A right underneath one sliced line of pattern B until the entire two patterns are completed in another background pattern. When the viewer sees through the transparent plastic, it functioned as convex lens, the refraction occurred, and the viewer only sees one pattern at one time, and when the viewer changes the viewing angle, he or she will see the other pattern. The viewer is seeing only two different static patterns (pictures) actually.

### SUMMARY OF THE INVENTION

The primary objective of the present invention is to provide a sign tag, which will show a dynamic view when a viewer changing his or her viewing angle on the tag.

According to the objective of the present invention, a sign tag comprises a transparent main member having convex members at a side thereof and a pattern at the opposite side thereof and there is a phase deviation between said pattern and said convex members. The pattern has compressed elements and the convex members serve as convex lens to refract lights reflected from the relative compressed elements of the pattern to form viewing results to a viewer. The positions of the viewing results are changed according to the viewing angle of the viewer such that the viewer will get a dynamically visual effect on the sign tag when he/she changes the viewing angles continuously relative to the sign tag.

The method of manufacturing the sign tag comprises the step of preparing the transparent main member and then providing the convex members and the pattern on the opposite sides of the main member respectively.

### BRIEF DESCRIPTION OF THE DRAWINGS

FIG. 1 is a perspective view of a first preferred embodiment of the present invention;

FIG. 2 is a sectional view along a 2-2 line in FIG. 1;

FIG. 3 is a perspective view of a viewer watching the sign tag and showing how the light retracted via the convex member;

FIG. 4 is a perspective view in part of the first preferred embodiment of the present invention, showing the formation of image on the sign tag;

FIG. 5 is similar to FIG. 4, showing the formation of image on the sign tag when viewing angle being changed in an angle θ;

FIG. 6 is perspective view of a second preferred embodiment of the present invention;

FIG. 7 is perspective view of a third preferred embodiment of the present invention, and

FIG. 8 is a flow chart of a method by which manufactures the sign tag of the present invention.

### DETAILED DESCRIPTION OF THE PRESENT INVENTION

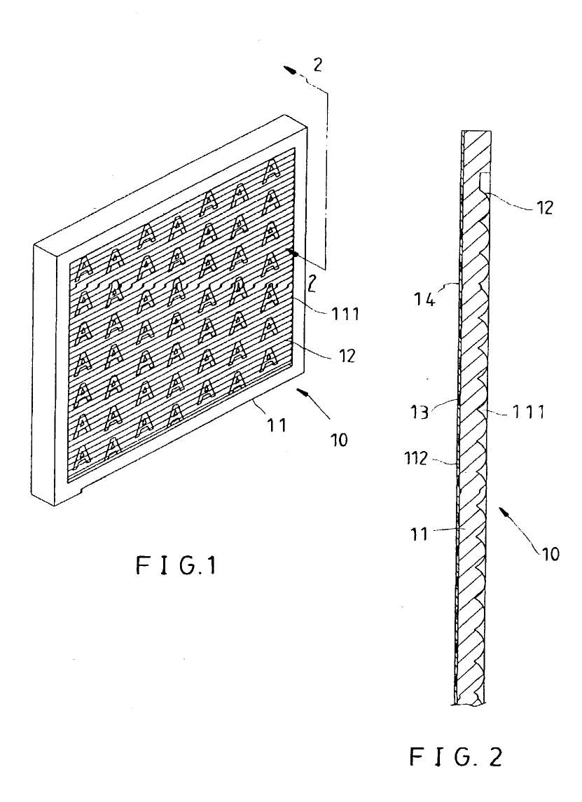

Please refer to FIG. 1 and FIG. 2, a sign tag 10 of the first preferred embodiment of the present invention comprises a main member 11, which is made from a transparent material into a plank or plate element. The transparent materials can be glasses, acrylic-plastic sheets (acrypoly), silicon plastic, thermoplastic polyurethane film and PVC etc. The main member 11 has a first side 111 and a second side 112 which is opposite from the first side 111. The main member 11 has a plurality of convex members 12 at the first side 11 thereof. The convex members 12 are strip-like and arranged parallel in a predetermined interval on the first side 111 of the main member 11. The convex members 12 make the first side 111 of the main member 11 having a zigzagged transparent surface and they serve as lines of convex lens in parallel. The main member 11 has a pattern 13 on the second side 112 of the main member 11. The pattern 13 consists of compressed elements 131 which can be signs, icons or texts which are compressed along a height orientation and are uncompressed along a width orientation. The compressed orientations of the compressed elements 131 are substantially perpendicular to the elongated orientations of the convex members 12, in another words, the uncompressed orientations of the compressed elements 131 are substantially parallel to the elongated orientations of the convex members 12. I have found that included angles between the uncompressed orientations of the compressed elements 131 and the elongated orientations of the convex members 12 are within 0 to 15 degrees that will format images too. The pattern 13 is compressed letters of A as shown in FIGS. A base layer 14 is provided on the second side 112 of the main member 11 sheltering the pattern 13. The base layer 14 serves as the background color of the pattern 13, it also has another function of protecting the pattern 13 result from being scratched.

In the present embodiment, the main member 11 is made from TPU (thermoplastic polyurethane film) which is an environmental safe material, and it eliminates concerns over the possible toxicity and air pollution arising from waste incineration. Decomposition will also be accomplished within 3-5 years after waste disposal material were buried underground. The convex members 12 are made from ultrasonic sealing, high frequency sealing or hot plate welding the first side 111 of the main member 11. It also can be done by texturing or other known techniques to provide the convex members 12 on the first side 111 of the main member 11. The pattern 13 is printed on the second side 112 of the main member 11 directly. The pattern 13 also can be printed on the base layer 14, and then attach the base layer 14 on the main member 11 with the side having the pattern 13.

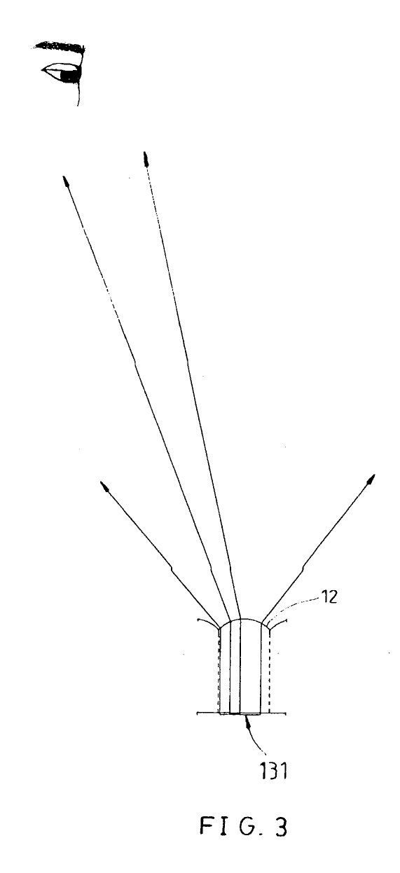

FIG. 3 shows how light reflected from the compressed element 131 and refracted via the convex members 12. There is only light reflected from a part of the compressed element 131 (the black region shown in FIG. 3) will format an image in eyes of a view in a specific viewing angle, light reflected from the rest part of the compressed element 131 (the blank region shown in FIG. 3) will be emitted to other orientations via the convex member 12. In the other words, viewer only can see a specific part of a compressed element 131 via the relative convex member 12 in a specific viewing angle. Such that, a viewer will see different parts of the compressed elements 131 because they have different viewing angle related to the viewer, and there will be some compressed elements 131 which can be seen because of the viewing angles relative to the viewer. Basically, the viewer will see many formation images, which are combinations of the formation images of specific continuous compressed elements 131.

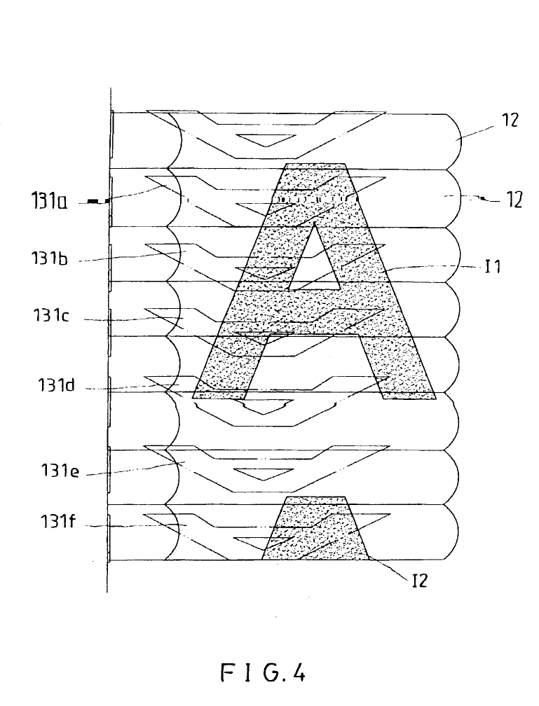

FIG. 4 shows formation images of combination I (which are A letters shown in FIG.) on the sign tag seen by a viewer in a specific viewing angle. As described above, formation images of the continuous compressed elements 131a˜131d will combine a formation image of combination I1 via relative convex members 12 on the sign tag and other formation images of combination I2 are formatted by other relative continuous compressed elements 131 and convex members 12. Typically, the formation images of combination I are enlarged and upside down, but we also found that the formation images of combination I will be just enlarged images without upside down effect when we applied different curvatures and chord lengths of the convex members 12.

The issues of how many formation images of the compressed elements 131 will combine a formation image of combination I and the ratio of enlargement of the formation image of combination I relate to curvatures and chord lengths of the convex members 12 and the intervals of the compressed elements 131. Typically it will get a larger ratio of enlargement of the formation image of combination I when the intervals of the compressed elements 131 are smaller. Manufacturers can change the parameters of above to get desired formation image of combination I.

In fact, the formation images of the compressed elements 131 of a formation image of combination I are distinctive and even twisted in the boundaries. But they are so small that the viewer cannot identify them and only see continuous formation images of combination I on the sign tag of the present invention.

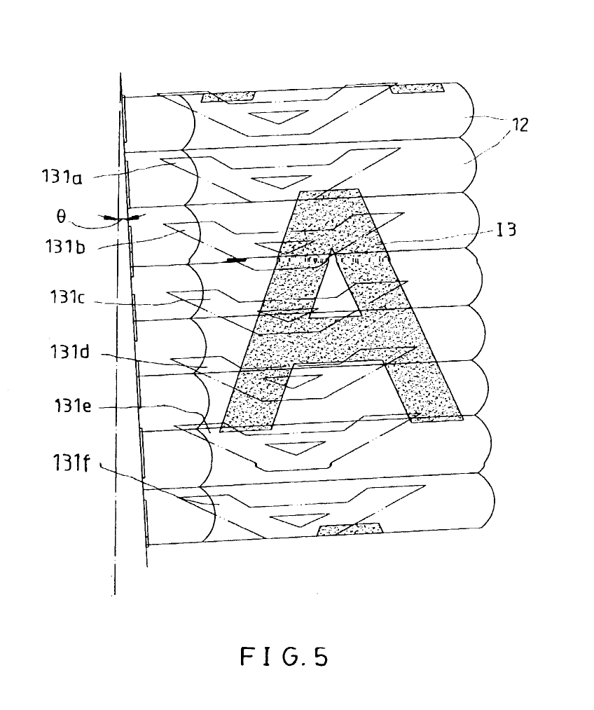

FIG. 5 shows the viewer seeing the sign tag in another viewing angle (the sign tag is turned an angle θ relative to the viewer as shown in FIG.). Other compressed elements 131b˜131e will combine their format images into a formation image of combination 13. The position of the formation image of combination 13 is lower relative to the position of the formation image of combination I1. With the effect of persistence of vision, the viewer will see an image of A letter shifting.

As a result, while a viewer watches the sign tag 10 of the present invention and changes the viewing angles relative to the sign tag 10, he/she will get a dynamically visual effect of A letters shifting on the main member 11, as the theory of persistence of vision, which is similar to the animated cartoon.

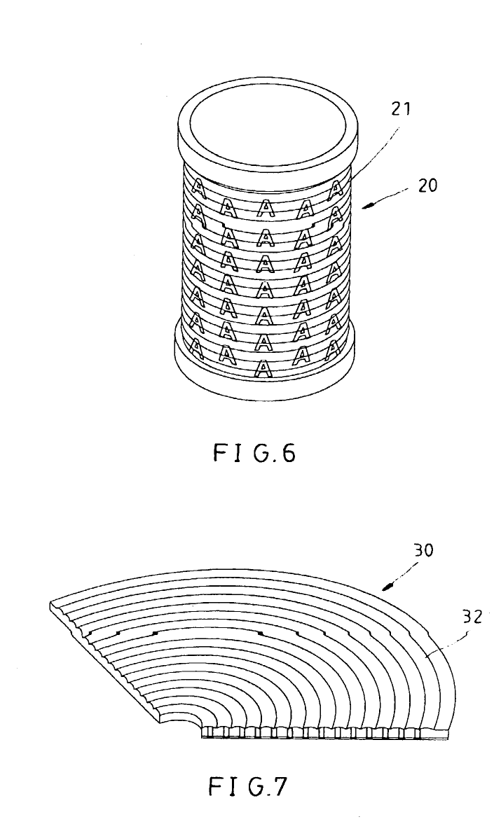

Please refer to FIG. 6, a sign tag 20 of the second preferred embodiment of the present invention, which is similar to the first preferred embodiment except that a main member 21 is made into a tube-like element. It can be mounted on a handle of a bicycle or the like. For the same reason, the sign tag of the present invention can be made into any shape of tri-dimensionality to meet the element on which the sign tag is mounted.

FIG. 7 shows a sign tag 30 of the third preferred embodiment of the present invention, which provides curved convex members 32 with same center of curvature. The convex members also can be made into annular shape with same center of circle.

It has to be mentioned here, we do not only compress the heights of the compressed elements of the pattern, but also need to enlarge or compress the widths of the compressed elements of the pattern to achieve our desirable result in certain applications, especially in the conditions of that the main member is made into tube-like or not flat element or the convex members is curved or circular.

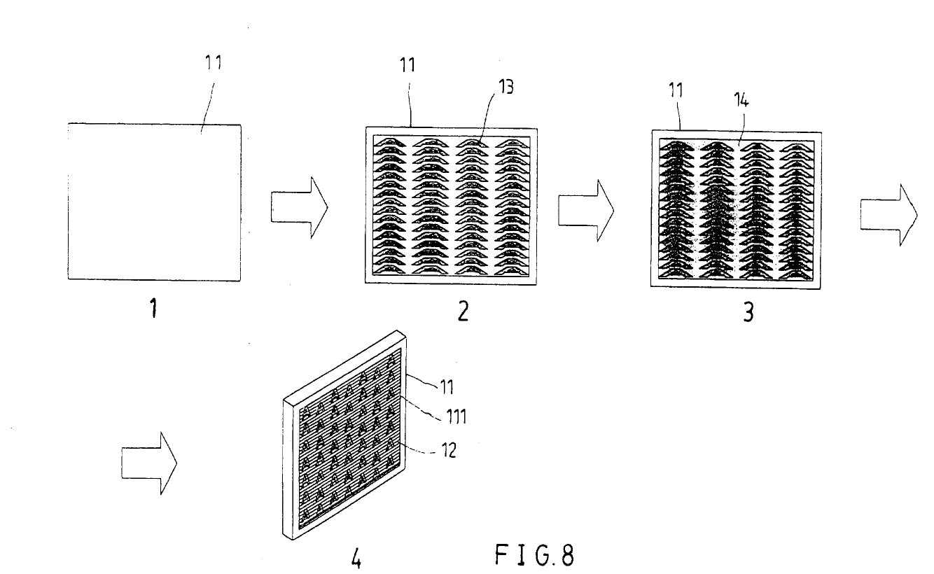

FIG. 8 shows a flow chart of how to manufacture the sign tag of the present invention, which comprises the steps of 1) prepare a transparent main member 11 with a first side 111 and a second side 112, which is made from TPU (thermoplastic polyurethane film) into a plate element with a thickness larger than 1.0 mm, 2) print a pattern 13 consisting of compressed signs, icons, texts or letters on the second side 112 of the main member 11, 3) coat a base layer 14 on the second side 112 of the main member 11 sheltering the pattern 13 and 4) provide convex members 12 on the first side 111 of the main member 11.

An alternative process is providing the convex members 12 on the first side 111 of the main member 11 before the pattern 13 and the base layer 14 are provided on the second side 112 of the main member 11.

The base layer 14 also can be a sheet element original and print the pattern 13 on it and then attach the base layer 14 on the second side 112 of the main member 11 with the side having the pattern 13.

As described above, the convex members 12 can be made from ultrasonic sealing, high frequency sealing, hot plate welding, texturing or any known technique to provide them on the first side 111 of the main member 11. It also can be done by s to provide the convex members 12 on the first side 111 of the main member 11.

Please refer to FIG. 8 again, the compressed elements 131 of the pattern 13 are only compressed their heights, and their widths remains as the same. In another words, the compressed elements 131 of the pattern 13 each has a compressed orientation (the height orientation) and an uncompressed orientation (the width orientation), wherein the compressed orientations of the compressed elements 131 are substantially parallel to an elongated orientations of the convex members 12. FIG. 8 shows a result of the compressed elements 131 of letters A. The compressed letters 131 are magnified through the relative convex members 12, which serves as convex lens, to recover their originally planned sizes. The numbers of the overlapped letters result can be pre-set. The original compressed elements 131 will be overlapped mapping into a meaningful and clear signs or texts. Due to the theory of the persistence of vision of human beings, the viewer changes the viewing angles to achieve dynamical shifting visual effect on the sign tag of the present invention. The elements shifting result is in corresponding to the movement of the viewing angles of the viewer.

This invention creates a visual illusory effect which comes out with a marvelous effect to human eyes, with the compressed (puzzled) signs, texts or icons of the pattern, pre-arranged layout and production process, this invention create very high barriers for the pirated copycats.

This invention can be utilized in any commercial product, which comes along with the logo, trademark, service mark or signed tag. The applicable fields are such as shoes, sneakers, clothing, fashion accessories, hats, luggage, electronic products or any products come with a label or tag which the proprietors want to promote the brand names as well as protect their interest.

In this invention, a different combination of signs, texts or icons of the pattern can be arranged in certain portion of the tag, also a fluorescent ingredient can be added on in the printing process to make the tag more distinguishable or to create a warning effect.

What is claimed is:

1. A sign tag, comprising:
a main member made of transparent material and having a first side and a second side which is opposite from said first side;
convex members provided on said first side of said main member to serve as convex lens, and
a pattern having compressed elements provided on said second side of said main member;
wherein there is a phase deviation between said compressed elements of said pattern and said relative convex members.

2. The sign tag as defined in claim 1, further comprising a base layer provided on said second side of said main member sheltering said pattern.

3. The sign tag as defined in claim 1, wherein said convex members are formed on said first side of said main member directly.

4. The sign tag as defined in claim 1, wherein said convex members are curved elongated elements and are substantially arranged in a pattern with a single center of curvature.

5. The sign tag as defined in claim 1, wherein said convex members are annular elements and are substantially arranged in a pattern with a single center of circle.

6. The sign tag as defined in claim 1, wherein said main member is made into a tube-like element.

7. The sign tag as defined in claim 1, wherein said main member is made into a tri-dimensionality element.

8. A method of making the sign tag of claim 1, comprising the steps of:
preparing a transparent main member having a first side and a second side which is opposite from said first side, and
providing convex members, a pattern having compressed elements and a base layer on said first side and said second side of said main member respectively wherein said base layer sheltering said pattern.

9. The method as defined in claim 8, wherein said pattern is provided on said base layer at a side thereof and then said base layer is attached on said main member with the side having said pattern.
